(19) United States
(12) Patent Application Publication
(10) Pub. No.: US 2009/0262598 A1
(43) Pub. Date: Oct. 22, 2009

(54) Fluid Mixing Device and Method

(76) Inventor: David F. Brashears, Orlando, FL (US)

Correspondence Address: NIXON & VANDERHYE, PC, 901 NORTH GLEBE ROAD, 11TH FLOOR, ARLINGTON, VA, 22203, US

(21) Appl. No.: 12/104,017

(22) Filed: Apr. 16, 2008

(51) Int. Cl. B01F 15/02; B01F 15/06; G05D 11/02

(52) U.S. Cl. 366/149; 366/181.5; 366/152.1; 366/178.1; 366/178.3

(57) ABSTRACT

A mixing device for consistently mixing a primary fluid and at least a secondary fluid includes a primary fluid inlet in fluid communication with a first mixing orifice, and a secondary fluid inlet in fluid communication with a second mixing orifice. A mixing area receives the primary fluid and the secondary fluid via the first and second mixing orifices, respectively. A size of and thus flow through the first and second mixing orifices is variable based on a pressure of the primary fluid and the secondary fluid through the respective mixing orifices.

### CROSS-REFERENCES TO RELATED APPLICATIONS

(NOT APPLICABLE)

### STATEMENT REGARDING FEDERALLY SPONSORED RESEARCH OR DEVELOPMENT

(NOT APPLICABLE)

### BACKGROUND OF THE INVENTION

The invention relates to mixing fluids and, more particularly, to a mixing device and method that achieves consistent mixing at varying processing rates without the use of a powered mixing device.

Due to environmental concerns and desire to lower energy costs, there has been a push to produce hot mix asphalt paving materials at lower temperatures. Hot mix asphalt (HMA) is typically a mixture of various size aggregates and asphalt cement with the asphalt cement used to hold the aggregates together as well as hold the total pavement in place.

Asphalt cement (AC) is a product produced by oil refineries and is a heavy petroleum product that is essentially a solid at normal ambient temperatures, but is a liquid at higher temperatures. The melting point and viscosity of the AC depends on its grade, temperature, and additives. The goal is to have an AC that will allow for easy production and placement of the pavement material but will cool into a strong, durable pavement.

Increasing the temperature of the mixture reduces the viscosity of the asphalt cement allowing it to coat the aggregates more uniformly and makes the mixture more fluid, allowing for easier placement of the HMA. Increasing the temperature, however, requires energy and also can lead to emissions of organic gases from the AC. These gases can become air pollutants if not captured. The challenge then is to utilize an AC that will provide the correct properties at ambient temperatures, will provide satisfactory viscosity at elevated temperatures for proper placement, but that will have as low a temperature as feasible during pavement construction to minimize energy requirements and emissions.

Various mechanical systems and additives have been used to enhance the properties of the AC, making it more workable at lower temperatures. The most common technique is to introduce some water into the process to cause the AC to foam. The foaming results when the hot AC contacts the water causing conversion of the water from a liquid to a gas (steam) and being contained in the asphalt cement. The foamed asphalt cement has a dramatically larger volume and reduced viscosity, making it easier to coat the aggregates and maintain better workability of the mixture at lower temperatures. To hold the steam in the AC foam, the AC must retain enough viscosity and cohesiveness to encapsulate the steam.

Foaming of the asphalt cement can be achieved by various means including direct injection of water into the asphalt cement; injection of water into the HMA mixture; injection of steam at various points in the process; introduction of hydrated mineral additives which release moisture with temperature; use of asphalt cement emulsions, and by allowing/controlling residual moisture in the aggregates.

1. Retained moisture: The most obvious solution is to allow for some residual moisture in the aggregates when the asphalt cement is mixed with the aggregates. Unfortunately, it is difficult to control the amount of moisture retained due to variations in the moisture content of the aggregates introduced to the dryer, production rate changes, as well as the properties within the aggregates. Having excessive amounts of water also can produce undesirable consequences such as adhesion problems between the AC and the aggregates.

2. Steam injection: Steam injection is expensive because of the need for a steam boiler, and controlling the introduction of the steam to the asphalt cement and achieving retention of the steam in the asphalt cement can be difficult.

3. Chemical additives: Various chemicals have also been used to modify the asphalt cement viscosity, but these typically are quite expensive and can have undesirable affects on the final pavement or can actually increase pollutant emissions. Hydrated minerals are the most typical additive, but the manner in which they are mixed with the AC needs to be controlled, and the steam emitted should be contained in a consistent manner.

4. Asphalt cement emulsions: To achieve a stable emulsion, the amount of water required is about 30% of the total weight of the emulsion. To attain this type of emulsion requires the use of special chemical additives and mechanical processing. Since good AC foam only requires from 1 to 2% by weight of water, emulsions contain significantly higher water content than necessary. In addition, heating these emulsions to produce the foaming phenomena can cause the emulsion to break with very undesirable results.

5. Injection of water into the HMA mixture: To achieve the goal of reduced viscosity of the AC at lower temperatures, the steam evolved from the water injected must be encapsulated inside of the AC. Injecting the water onto the HMA mixture does not insure that the moisture will be mixed internal to the AC film.

6. Injection of water into the AC: Foamed AC can be produced by direct injection of water into the AC. To achieve consistent foam at varying production rates, however, either you must provide for powered mixing devices or have variable orifices and a means of controlling the interface between the mixing point of the two fluids. Alternatively, some systems employ multiple mixer systems which require that they be staged on and off as appropriate for a given production rate, but this results in step changes that do not ideally match the required conditions and involves much higher costs in both hardware, controls and maintenance.

There are available on the market so called “static mixers,” which have been devised to mix fluids as they pass through a transport line. See, e.g., U.S. Pat. No. 4,692,350. These mixing devices are of a fixed design. As a result, the design is essentially optimized for one production rate. If the flow area or orifice is too small, at high production rates, it will have an unacceptably high pressure drop. If the flow area or orifice is too large, at low production rates, there is too little energy to achieve a good mixture.

When mixing two liquids together in a continuous fashion at various rates, it is difficult to obtain good mixing at all production rates with conventional fixed orifice devices. As the production rate decreases, the pressure drop and mixing energy also decreases. This problem is especially acute when trying to thoroughly mix a very small quantity of one liquid with a much large quantity of a second. This potential problem is especially the case when mixing two liquids whereupon mixing one or both change state from a liquid to a gas. This can occur when, for example, water is injected into a second hot liquid in order to achieve foam.

To generate stable consistent quality foam, a well mixed composite is desirable in order to obtain small, evenly sized bubbles. Foamed asphaltic material is very useful since it decreases the base material viscosity, provides a larger volume to assist in coverage of the aggregates to be coated, and helps to improve the workability of the final product.

To achieve such foaming consistenly at varying production rates, it is desirable to provide for direct mixing of two or more fluids through variable orifice nozzles without the use of power mixing.

### BRIEF SUMMARY OF THE INVENTION

The device and method of the described embodiments provide for the mixing of two or more fluids using only the energy of the pumps or head supplying the fluids and achieve consistent mixing at varying processing rates without the use of a powered mixing device. The fluids can be either liquid or gaseous or a combination and can be at widely different flow rates, temperatures, and pressures.

The device and method utilize variable orifices for the fluids as a means to maintain relative consistency in impact energy at the point of contact of fluids at varying rates of flows. While the invention can be used with any two or more fluids, it is especially valuable when used with liquid fluids where one is a relatively smaller ratio of the other. It is also especially valuable when one of the liquids changes to a gas, producing mixture foam.

For example, when making asphalt foam, which can be useful in making road pavements, or in the production of any materials where asphalt or other coating is desirable, a small percentage, one to two percent by weight, of water or other fluid can be injected into hot asphalt or other base material is used. Other exemplary materials besides road pavement materials where this would be useful is in the production of roofing shingles, the coating of tanks and piping for corrosion resistance, food products, etc. As one example, in the production of paving materials, the mixing of the water with the hot asphalt cement will result in a froth or foam, but the quality and stability of this foam will depend on size and consistency of the bubbles generated. The device could also be used to foam other materials such as food products, insulating materials; organic materials such as plastics, pesticides, fertilizers, lubricating oils, and crude oils and their derivatives, as well as various inorganic chemicals.

Since products such as hot mix asphalt are made at varying production rates, it is desirable to have a device that will provide consistent, quality mixing in order to achieve stable and consistent foam over the complete range of production rates. The smaller the bubbles, the more stable the foam will be, and in order to generate consistently small bubbles, good mixing is important at all production rates.

While this mixing device has been developed to primarily be used in the generation of foams, it could also be used when any two or more streams of fluids liquids or gases are required to be mixed on a continuous basis without the use of driven rotating or moving mixers. All of the mixing energy is provided by the pumping systems delivering the fluids to the in line mixing unit.

In an exemplary embodiment, a mixing device consistently mixes a number of primary fluids with at least a secondary fluid. The mixing device includes a mixer body housing including a primary fluid cavity in fluid communication with a primary fluid inlet, and a secondary fluid nozzle disposed within the primary fluid cavity and in fluid communication with a secondary fluid inlet. The secondary fluid nozzle includes a loaded valve that is biased closed. A mixing area is disposed within or adjacent the mixer body housing. Outlets of the primary fluid cavity and the secondary fluid nozzle are in fluid communication with the mixing area. A diaphragm is disposed adjacent the outlet of the primary fluid cavity and directs the primary fluid exiting the primary fluid cavity into contact with the secondary fluid.

Preferably, the secondary fluid nozzle includes a spring-biased valve that is opened when a pressure of the secondary fluid exceeds a predefined value. In this context, the valve of the secondary fluid nozzle may be configured to open farther as the pressure of the secondary fluid increases beyond the predefined value.

The outlet of the primary fluid cavity is preferably substantially concentric with the outlet of the secondary fluid nozzle. In one arrangement, the diaphragm includes a central opening in substantial axial alignment with the secondary fluid nozzle. In this context, the central opening may be adjustable according to a pressure of the primary fluid. The diaphragm may further include radial slits extending from the central opening. In another arrangement, two or more diaphragms may be utilized, where the radial slits in the first diaphragm are offset from the radial slits in the second diaphragm or subsequent diaphragms.

The mixing area may comprise a mating piping flange connected to the mixer body housing and including a mixing cavity. The outlets of the of the primary fluid cavity and the secondary fluid nozzle are preferably in fluid communication with the mixing cavity. In this context, the diaphragm may be disposed between the mixer body housing and the mating piping flange.

In another exemplary embodiment, a mixing device includes a primary fluid inlet in fluid communication with a first mixing orifice; a secondary fluid inlet in fluid communication with a second mixing orifice; and a mixing area receiving the primary fluid and the secondary fluid via the first and second mixing orifices, respectively. A size of and thus flow through the first and second mixing orifices is variable based on a pressure of the primary fluid and the secondary fluid through the respective mixing orifices.

In yet another exemplary embodiment, a method of mixing a primary fluid and a secondary fluid in the mixing device of the described embodiments includes the steps of flowing the primary fluid into the primary fluid cavity via the primary fluid inlet; flowing the secondary fluid into the secondary fluid nozzle via the secondary fluid inlet; loading the valve of the secondary fluid nozzle to ensure that a pressure of the secondary fluid in the mixing area exceeds a predefined minimum pressure; and mixing the primary fluid and the secondary fluid in the mixing area by directing the primary fluid exiting the primary fluid cavity into contact with the secondary fluid.

### BRIEF DESCRIPTION OF THE DRAWINGS

These and other aspects and advantages will be described in detail with reference to the accompanying drawings, in which:

FIG. 1 is a perspective view of the mixing device described herein;

FIG. 2 is an end view of the mixing device;

FIG. 3 is a cross sectional view of the mixing device along line 3-3 in FIG. 2; and

FIG. 4 shows an exemplary alternative embodiment utilizing two diaphragms.

### DETAILED DESCRIPTION OF THE INVENTION

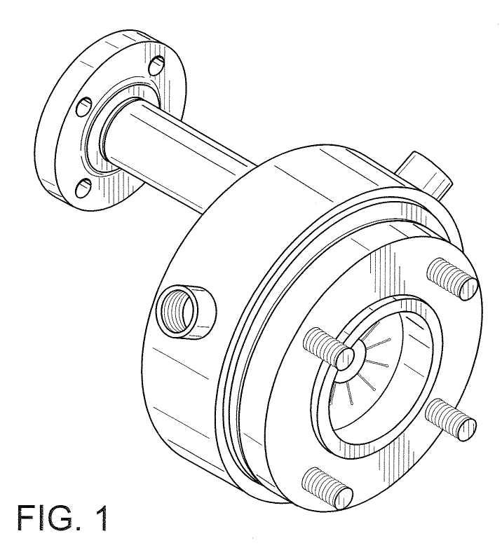

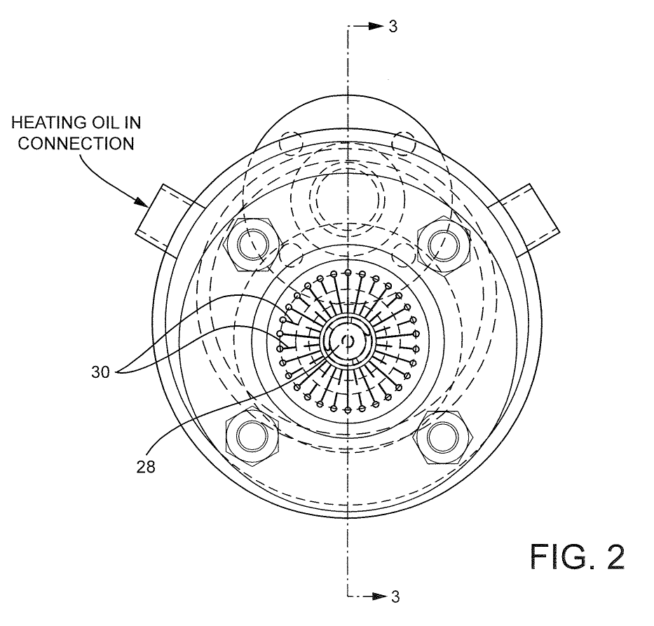

A preferred embodiment will be described with reference to FIGS. 1-3. A mixing device 10 is constructed to consistently mix a primary fluid with one or more secondary fluids. The mixing device 10 includes a mixer body housing 12 with a primary fluid cavity 14 in fluid communication with a primary fluid inlet 16. A centrally located secondary fluid nozzle 18 is disposed within the primary fluid cavity 14 and is in fluid communication with a secondary fluid inlet 20. The secondary fluid nozzle 18 includes a loaded valve 22 that is biased closed via a spring 24 or the like. The spring loaded valve 22 is constructed to open when the pressure of the secondary (lower) volume fluid is impressed behind the valve 22.

For applications where either the primary or secondary fluids must be maintained at elevated temperature to provide proper performance and/or flow characteristics of the fluid, a heating oil cavity 15 or jacket may be disposed adjacent the primary fluid cavity 14 around the mixing device. Hot thermal fluid can be circulated in this cavity in order to maintain the device at the proper temperature. This heating feature is also important when the system is started up to reheat product remaining in the device from the last run. There may also be some fluids that require cooling during the mixing operation (such as mixtures that result in exothermic reactions) and a cooling fluid could be circulated through the chamber 15 as required.

External to the centrally located nozzle 18 is a diaphragm or multiple diaphragms 26 that preferably have a hole 28 in the center slightly larger than the central nozzle 18 diameter. The diaphragm 26 has radial slits 30 extending from the central hole 28 to allow the diaphragm 26 to deflect when a fluid pressure is placed behind the diaphragm 26.

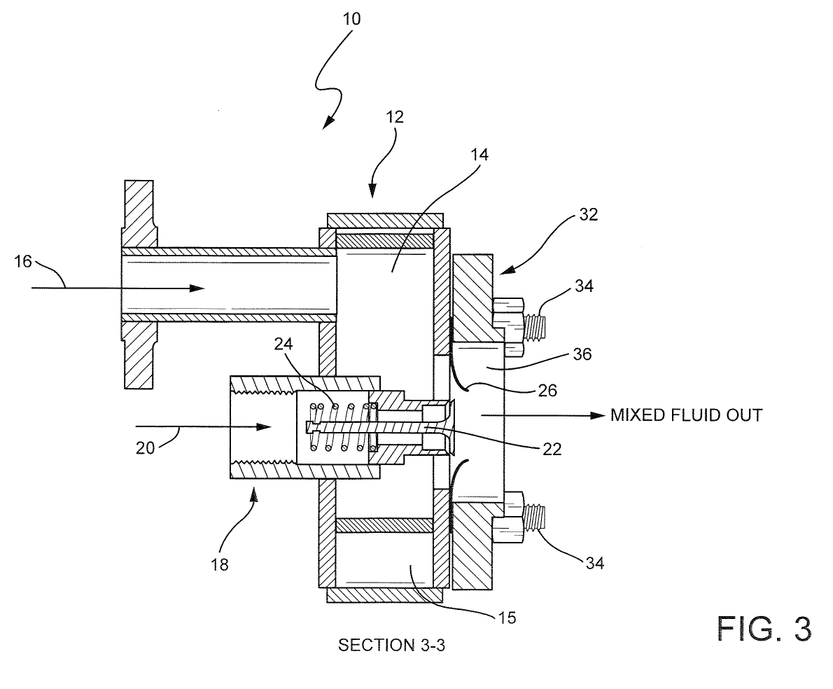

The diaphragm outside diameter is preferably held fixed in place by being captured between the mixer body housing 12 and a mating piping flange 32. The mating piping flange 32 is connected to the mixer body housing 12 by bolts 34 or the like and includes a mixing cavity 36. As shown in FIG. 3, outlets of the primary fluid cavity 14 and the secondary fluid nozzle 18 via the valve 22 are in fluid communication with the mixing cavity 36. As the flow of the primary (larger quantity) fluid is increased, the fingers of the diaphragm 26 will deflect allowing for increased flow area. The flow stream of the primary fluid will be directed toward the center nozzle 18 such that the primary fluid is placed in close proximity to the injection point of the secondary fluid.

The ratio of the fluids is typically maintained constant at all production rates. This is achieved by external metering of each fluid and ratio with typical process control devices. At low production rates, the primary fluid is held in extremely close proximity to the injection point of the secondary fluid(s). By preloading the valve spring 24 on the secondary fluid nozzle 18, a high pressure can be insured prior to the valve 22 opening. Since under these conditions, the valve 22 would only crack open providing a very narrow flow annulus, the exiting stream would be at high velocity and mixing energy. As the production rate increases, the flow rate of the secondary fluid(s) also increases causing the valve 22 to open farther with a still higher pressure drop across the orifice, which would depend on the initial spring loading and the spring constant.

On the larger flow, primary fluid side, a similar orifice variation will occur with varying flow with the pressure drop required dependent on the flow rate and the spring rate of the diaphragm 26 fingers. While the spring rate on the secondary fluid valve spring 24 would be nearly a constant, because of the physical design of the fingers on the diaphragm 26, the spring rate of the fingers may not be constant but may increase substantially with deflection. The spring rate of the diaphragm fingers can be changed by using different material types and thicknesses. It is expected that materials which have high flexibility and strength such as stainless steels or titanium alloys would be suitable, although these materials are only exemplary. Rubber or other elastomeric materials can also be used where they are chemically compatible with the fluids and can perform properly at the design process temperatures

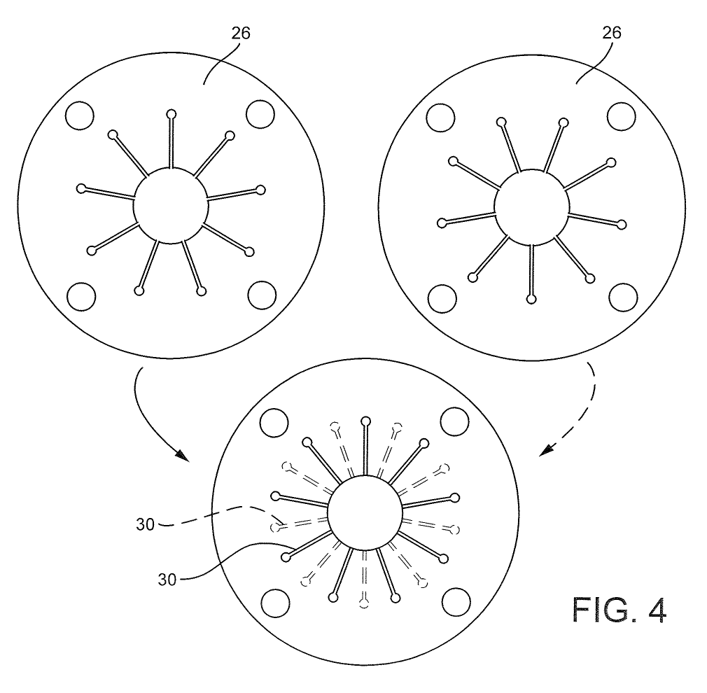

In an alternative embodiment, with reference to FIG. 4, two or more diaphragms 26 may be used where the slits 30 are not in alignment but are staggered. With two or more diaphragms 26 sandwiched together in such a manner, there would be no straight through flow area through the slits 30 themselves. This construction minimizes bypassing of the primary fluid through the slits 30 as the fingers deflect and keeps the flow of the primary fluid directed toward the center of the mixer and at the secondary fluid injection point.

Still another construction, although less desirable, may be a device where the diaphragm is fixed and solid in the center with slits radiating outward toward the outside diameter. A slit could be provided in the sidewall of the device, which could be either a constant size or be adjustable by providing a means using bellows to allow the slit to increase in size as the pressure of the secondary fluid is increased. This arrangement would be less desirable, however, because it would:

1. be more expensive to manufacture,

2. would result in a larger circumference of the flow slot for the secondary fluid,

3. would make heat jacketing difficult for fluids that must be maintained at elevated temperatures,

4. would result in smaller support cross section at the base of the blades, and

5. would require movement of the outer pipe section in order to achieve a variable slot for the secondary fluid.

With the embodiments described herein, because of the spring loading of the valve on the secondary fluid(s), if it is desirable to operate the system with just the primary fluid, the spring and valve design prevents the primary fluid from flowing into the secondary fluid delivery piping system. This is especially important when dealing with a fluid such as asphalt cement, which becomes solid at low temperatures. Having this type of material flow into the secondary fluid system piping could plug it or severely restrict the flow area.

Moreover, if the device is used to produce foam, the foaming action causes a significant expansion in the fluid volume. The design of the device allows for a substantially smaller flow area for the non-foamed materials, with a greatly expanded flow area for the foamed material.

Still further, for some fluids such as asphalt cement, it is desirable to be able to remove the primary fluid from the device and lines when not in production. This can be accomplished by reversing the pump delivering the primary fluid, producing suction rather than a positive pressure on the delivery piping to the mixing device. Because the diaphragms can deflect either upstream or downstream, the device does not prevent clearing of the flow lines in this manner.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A mixing device for consistently mixing a primary fluid with at least a secondary fluid, the mixing device comprising:
a mixer body housing including a primary fluid cavity in fluid communication with a primary fluid inlet;
a secondary fluid nozzle disposed within the primary fluid cavity and in fluid communication with a secondary fluid inlet, the secondary fluid nozzle including a loaded valve that is biased closed;
a mixing area disposed within or adjacent the mixer body housing, wherein outlets of the primary fluid cavity and the secondary fluid nozzle are in fluid communication with the mixing area; and
a diaphragm disposed adjacent the outlet of the primary fluid cavity, the diaphragm directing the primary fluid exiting the primary fluid cavity into contact with the secondary fluid.

2. A mixing device according to claim 2, wherein the mixer body housing further comprises a heating or cooling media cavity

3. A mixing device according to claim 1, wherein the secondary fluid nozzle comprises a spring-biased valve that is opened when a pressure of the secondary fluid exceeds a predefined value.

4. A mixing device according to claim 3, wherein the valve of the secondary fluid nozzle is configured to open farther as the pressure of the secondary fluid increases beyond the predefined value.

5. A mixing device according to claim 1, wherein the outlet of the primary fluid cavity is substantially concentric with the outlet of the secondary fluid nozzle.

6. A mixing device according to claim 5, wherein the diaphragm comprises a central opening in substantial axial alignment with the secondary fluid nozzle.

7. A mixing device according to claim 6, wherein the diaphragm is constructed such that the central opening is adjustable according to a pressure of the primary fluid.

8. A mixing device according to claim 1, wherein the diaphragm comprises a central opening in substantial axial alignment with the secondary fluid nozzle.

9. A mixing device according to claim 8, wherein the diaphragm is constructed such that the central opening is adjustable according to a pressure of the primary fluid.

10. A mixing device according to claim 8, wherein the diaphragm further comprises radial slits extending from the central opening.

11. A mixing device according to claim 1, wherein the diaphragm comprises at least a first diaphragm and a second diaphragm disposed facing each other.

12. A mixing device according to claim 11, wherein the at least first and second diaphragms each comprises a central opening in substantial axial alignment with the secondary fluid nozzle, and wherein the first and second diaphragms each further comprises radial slits extending from the central opening.

13. A mixing device according to claim 12, wherein the radial slits in the first diaphragm are offset from the radial slits in the second diaphragm.

14. A mixing device according to claim 1, wherein the mixing area comprises a mating piping flange connected to the mixer body housing and including a mixing cavity, and wherein the outlets of the of the primary fluid cavity and the secondary fluid nozzle are in fluid communication with the mixing cavity.

15. A mixing device according to claim 14, wherein the diaphragm is disposed between the mixer body housing and the mating piping flange.

16. A mixing device for consistently mixing a primary fluid with at least a secondary fluid, the mixing device comprising:
a primary fluid inlet in fluid communication with a first mixing orifice;
a secondary fluid inlet in fluid communication with a second mixing orifice; and
a mixing area receiving the primary fluid and the secondary fluid via the first and second mixing orifices, respectively,
wherein a size of and thus flow through the first and second mixing orifices is variable based on a pressure of the primary fluid and the secondary fluid through the respective mixing orifices.

17. A mixing device according to claim 16, wherein the second mixing orifice is positioned relative to the first mixing orifice and the first mixing orifice is constructed such that the primary fluid is directed toward the secondary fluid in the mixing area.

18. A method of mixing a primary fluid and at least a secondary fluid in the mixing device of claim 1, the method comprising:
flowing the primary fluid into the primary fluid cavity via the primary fluid inlet;
flowing the secondary fluid into the secondary fluid nozzle via the secondary fluid inlet;
loading the valve of the secondary fluid nozzle to ensure that a pressure of the secondary fluid in the mixing area exceeds a predefined minimum pressure; and
mixing the primary fluid and the secondary fluid in the mixing area by directing the primary fluid exiting the primary fluid cavity into contact with the secondary fluid.

19. A method according to claim 18, further comprising, prior to the mixing step, maintaining a desired ratio of the primary fluid to the secondary fluid.

20. A method according to claim 18, further comprising, prior to the mixing step, controlling an amount of the primary fluid through the diaphragm and an amount of the secondary fluid through the secondary fluid nozzle according to a pressure of the primary fluid and a pressure of the secondary fluid, respectively.
